(19) United States
(12) Patent Application Publication
(10) Pub. No.: US 2003/0179564 A1
(43) Pub. Date: Sep. 25, 2003

(54) Edge illuminated visual display apparatus

(76) Inventors: Joseph D. Ganci, Austin, TX (US); Anthony E. Allevato, Austin, TX (US)

Correspondence Address: Moster Wynne PC, Attn: Chad M. Herring, 1135 West Sixth Street, Suite 140, Austin, TX, 78703, US

(21) Appl. No.: 10/387,756

(22) Filed: Mar. 13, 2003

Related U.S. Application Data
(60) Provisional application No. 60/364,003, filed on Mar. 13, 2002.

(51) Int. Cl. G01D 11/28

(52) U.S. Cl. 362/27; 362/31; 362/231; 362/800

(57) ABSTRACT

A visual display apparatus, comprising a first panel formed of a substantially transparent first substrate material, the first substrate material being substantially colorless and the first substrate material defining a first major forward surface and an opposed first major rear surface spaced in a rearward direction from the first major forward surface. The first substrate material defines a continuous first outer edge connecting the first major forward surface and the first major rear surface, and the first outer edge comprises a first edge light entrance area. A second panel is disposed in parallel relation to the first panel and comprises a substantially transparent second substrate material having a color. The second substrate material defining a second major forward surface and an opposed second major rear surface spaced in a rearward direction from the second major forward surface. The second substrate material define a continuous second outer edge connecting the second major forward surface and the second major rear surface, and the second outer edge comprises a second edge light entrance area. A light source is operable to produce light for illuminating the first edge light entrance area and the second edge light entrance area. The first edge light entrance area is adapted to transmit the illuminating light into the first substrate material to illuminate the first panel. The second edge light entrance area is adapted to transmit the illuminating light into the second substrate material to illuminate the second panel. The first substrate material has defined therein a plurality of spaced light extracting first deformations disposed to cause emission of a portion of the illuminating light in the first panel. The second substrate material has defined therein a plurality of spaced light extracting second deformations disposed to cause emission of a portion of the illuminating light in the second panel.

The inventors of the present application hereby claim priority under 35 U.S.C. §119(e) of the filing date of Provisional Application Serial No. 60/364003 filed by the same inventors and titled “Lighting Apparatus”. The referenced Provisional Application is hereby incorporated by reference into the present application.

### FIELD OF THE INVENTION

The present disclosure relates generally to visual displays. More particularly, the present disclosure relates to edge illuminated visual displays.

### BACKGROUND OF THE INVENTION

Edge illuminated signs are known. An edge-illuminated sign is disclosed in U.S. Pat. No. 2,206,866. An edge lighted sign is disclosed in U.S. Pat. No. 2,499,824. Another edge lighted sign is disclosed in U.S. Pat. No. 2,564,110. U.S. Pat. No. 4,791,745 discloses a black light display system. U.S. Pat. No. 4,918,578 discloses a visual display device illuminated by edge-lighting means. U.S. Pat. No. 5,369,553 discloses an illuminated panel device. U.S. Pat. No. 5,636,914 also discloses an illuminated panel device.

### SUMMARY OF THE INVENTION

The present disclosure provides a visual display apparatus which comprises a plurality of substantially transparent panels disposed or stacked in abutting parallel relationship. A light source, preferably a series of spaced LED's, is operable to produce light for edge illuminating the panels and to transmit light into the substrate material forming each panel. A plurality of spaced light extracting deformations is disposed to cause emission of a portion of the light in each respective panel. The deformations in the various panels are arranged in spaced patterns which provide a desired three dimensional visual representation.

The disclosure thus provides a brightly illuminated, colorful, three-dimensional visual display apparatus. The visual display apparatus is relatively inexpensive to operate. The visual display apparatus also is producible at a relatively low unit cost using CNC machining. The visual display also stays cool and can operate in outdoor weather if so desired.

Other features and advantages of the invention will become apparent to those of ordinary skill in the art upon review of the following detailed description, claims and drawings.

### BRIEF DESCRIPTION OF THE DRAWINGS

The present disclosure will be better understood from the following detailed description of embodiments, with reference to the drawings:

FIG. 1 is a front elevation view (not to scale) of a visual display apparatus according to an embodiment of the disclosure;

FIG. 2 is a side view, partially in section, taken on line 2-2 of FIG. 1; and

FIG. 3 is a schematic illustration of the embodiment shown in FIG. 1.

Before an embodiment of the invention is explained in detail, it is to be understood that the invention is not limited in its application to the details of construction and the arrangement of components set forth in the following detailed description or illustrated in the drawings. The invention is capable of other embodiments and of being practiced or carried out in various ways. Also, it is to be understood that the phraseology and terminology used herein is for the purpose of description and should not be regarded as limiting.

### DETAILED DESCRIPTION OF EMBODIMENTS

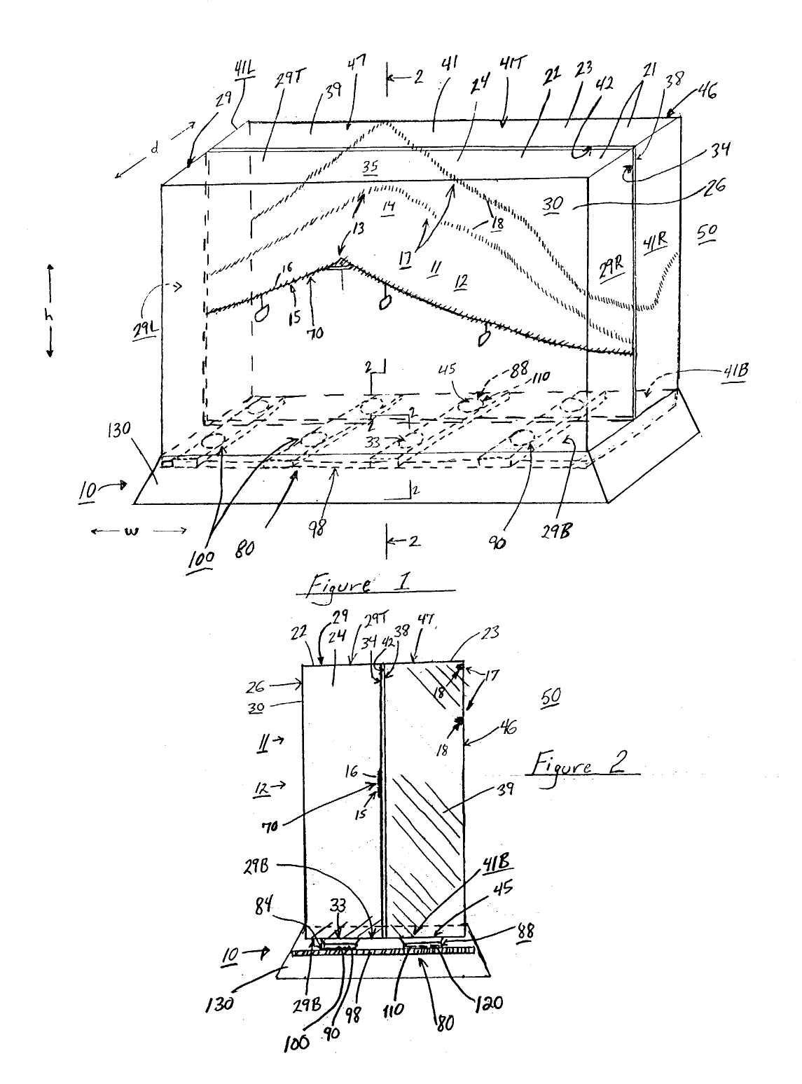

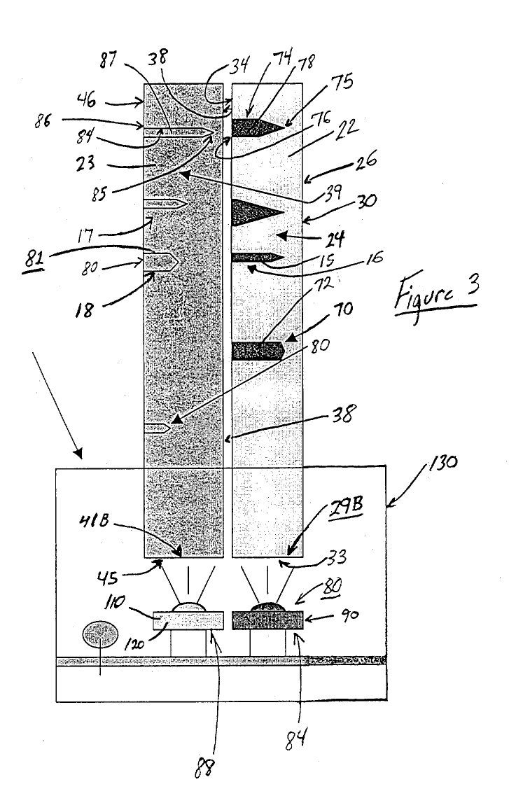

Illustrated in FIGS. 1 through 3 is a visual display apparatus 10 according to one embodiment of the disclosure. The visual display apparatus 10 includes a viewable region 11 disposed for viewing by a person standing or sitting in spaced relation to the visual display apparatus 10. The viewing person or viewer stands in a forward direction from the viewable region 11 and visual display apparatus 10. A rearward direction is defined in the direction opposite from the forward direction. In the illustrated embodiment, the viewable region 11 extends in three dimensions and thus comprises a three-dimensional viewable region 12. The three-dimensional viewable region 12 has substantial width (w), height (h) and depth (d).

A viewable image 13 is displayed in the viewable region 11. The viewable image 13 may include any combination of visual indicia, including letters, numerals, symbols, designs, images or visual representations. In one embodiment, the viewable image 13 comprises a three-dimensional visual representation 14 displayed in the three-dimensional viewable region 12. The three-dimensional visual representation 14 has substantial width, height and depth. In one embodiment, the three-dimensional visual representation 14 comprises in the foreground a first grouping 15 of spaced foreground visual elements 16 and in the background a second grouping 17 of spaced background visual elements 18. The first grouping 15 of spaced foreground visual elements 16 and second grouping 17 of spaced background visual elements 18 interact to provide the viewer a striking three-dimensional visual display. In one embodiment (FIG. 3), the foreground visual elements 16 are spaced in width (w) and height (h) in a first plane (P1) at depth (d1), and the background visual elements 18 are spaced in width (w) and height (h) in a second plane (P2) at depth (d2).

The three-dimensional viewable region 12 is defined by a plurality of adjacent illuminated panels 21. One or more air gap layers may exist between adjacent illuminated panels 21. One or more of the panels may not be separately illuminated, and may be indirectly illuminated by adjacent illuminated panels 21. In the embodiment illustrated in FIGS. 1-3, the three-dimensional viewable region 12 comprises adjacent illuminated first and second panels 22 and 23. In other embodiments, more than two illuminated panels may be advantageously employed. FIG. 4, for example, is a schematic illustration of an alternative embodiment comprising five illuminated panels.

Returning to the specific embodiment illustrated in FIGS. 1-3, the first panel 22 is in the form of a sheet having a rectangular cross-sectional shape. The first panel 22 is formed of a substantially transparent first substrate material 24. Although further aspects of the first substrate material 24 are described below, in one embodiment, the first substrate material 24 is a sheet of transparent acrylic material.

The first substrate material 24 defines a generally planar first major forward surface 26. When observed by a viewer, the first major forward surface 26 comprises a first major viewing surface 30. The first major viewing surface 30 is substantially transparent, generally faces the forward direction and is viewable by the viewer. A suitable minor protective layer of transparent coating material (not shown) may be interposed upon the first major viewing surface 30 to prevent the occurrence of scratches.

The first substrate material 24 also defines a generally planar first major rear surface 34. The first major rear surface 34 is spaced rearward from and is disposed in parallel, opposed relation to the first major forward surface 26. The first major rear surface 34 generally faces away from the forward direction and thus is not readily viewable by the viewer. The first major viewing surface 30, the first substrate material 24 and the first major rear surface 34 are sufficiently transparent that the second panel 23 is viewable through the illuminated first panel 22 by the viewer.

The first substrate material 24 defines a continuous first outer edge 29. The first outer edge 29 extends between and connects the spaced first major forward surface 26 and the first major rear surface 34. The first outer edge 29 is of uniform width and extends perpendicular to the planar first major forward surface 26 and the first major rear surface 34. In other embodiments (not shown), portions of the first outer edge may not be of uniform width and may not extend perpendicular to the generally planar major surfaces of the panel. Returning to the specific embodiment illustrated, where the first illuminated panel 22 is a panel of rectangular cross-sectional shape, the first outer edge 29 is rectangular in shape and thus comprises a pair of spaced, parallel, elongated top and bottom edge portions 29T and 29B connected by a pair of spaced, parallel, elongated left and right edge portions 29L and 29R.

The first outer edge 29 includes a first edge light entrance area 33. The first edge light entrance area 33 transmits light into the first substrate material 24 in the direction generally parallel to the first major forward surface 26 and first major rear surface 34. The portion of light transmitted into the first substrate material 24 is identified as “transmitted light”. Transmitted light thus travels in the first substrate material 24 in the direction generally parallel to the first major forward surface 26 and first major rear surface 34. The first edge light entrance area 33 can be of any suitable size or location. In some embodiments (not shown) a plurality of spaced first edge light entrance areas may be advantageously employed. In the specific embodiment illustrated, the first edge light entrance area 33 extends along substantially the entire bottom edge portion 29B of the first panel 22.

The first outer edge 29 also includes a first major edge portion 35 which adjoins the first edge light entrance area 33. In the specific embodiment illustrated, the first major edge portion 35 comprises the left and right edge portions 29L and 29R adjoining opposite ends of the first edge light entrance area 33, and the top edge portion 29T which connects the left and right edge portions 29L and 29R. In the illustrated embodiment, the first major edge portion 35 is coated with an internally reflective material (not shown), as is known in the art. The internally reflective material redirects substantially all light which might exit through the first major edge portion 35 back into the first substrate material 24. Any suitable internally reflective material may be utilized, such as, for example, reflective metallic paint. In other embodiments (not shown), the first major edge portion 35 is not coated and may permit light to escape and thus illuminate the first major edge portion 35 of the first outer edge 29.

In the illustrated embodiment, the second illuminated panel 23 is stacked adjacent and in closely abutting, parallel relation to the first illuminated panel 22. In the specific embodiment illustrated, the second illuminated panel 23 is in the form of a sheet having a rectangular cross-sectional shape. The second illuminated panel 23 is formed of a substantially transparent second substrate material 39. Although further aspects of the second substrate material 39 are described below, in one embodiment, the second substrate material 39 is a sheet of transparent acrylic material. The second substrate material 39 defines a generally planar second major forward surface 38 having a second major viewing surface 42. The second major viewing surface 42 is substantially transparent, generally faces the forward direction and is viewable by the viewer. The second major forward surface 38 is adjacent to and closely abuts the first major rear surface 34 in close parallel relation thereto. In the particular embodiment illustrated, close abutment of the second major forward surface 38 and the first major rear surface 34 prevents the existence of a substantial air gap there between. In one embodiment (not shown) an air gap may exist between the second major forward surface and the first major rear surface.

The second substrate material 39 also defines a generally planar second major rear surface 46. The second major rear surface 46 is spaced rearward from and is disposed in parallel, opposed relation to the second major forward surface 38. The second major rear surface 46 generally faces away from the forward direction and thus is not readily viewable by the viewer. In the particular embodiment illustrated in FIGS. 1-3, the second major rear surface 46 is substantially transparent, such that a rear space 50 located in the rearward direction away from the viewer and behind the display apparatus 10 is viewable beyond and through the first and second illuminated panels 22 and 23. In the illustrated embodiment, the rear space 50 is empty. In other embodiments, the rear space 50 may not be viewable through the first and second panels 22 and 23.

The second substrate material 39 defines a continuous second outer edge 41. The second outer edge 41 extends between and connects the spaced second major forward surface 38 and the second major rear surface 46. In the specific embodiment illustrated, where the second illuminated panel 23 is a sheet of rectangular cross-sectional shape, the second outer edge 41 is rectangular in shape and comprises a pair of spaced, parallel, elongated top and bottom edge portions 41T, 41B connected by a pair of spaced, parallel, elongated left and right edge portions 41L, 41R.

The second outer edge 41 includes a second edge light entrance area 45. The second edge light entrance area 45 transmits light into the second substrate material 39 in the direction generally parallel to the second major forward surface 38 and second major rear surface 46. The second edge light entrance area 45 can be of any suitable size or location. In the specific embodiment illustrated, the second edge light entrance area 45 extends along substantially the entire bottom edge portion 41B of the second panel 23.

The second outer edge 41 also includes a second major edge portion 47 which adjoins the second edge light entrance area 45. In the specific embodiment illustrated, the second major edge portion 47 comprises the left and right edge portions 41L and 41R adjoining opposite ends of the second edge light entrance area 45, and the top edge portion 41T which connects the left and right edge portions 41L and 41R. In the illustrated embodiment, the second major edge portion 47 is coated with an internally reflective material. The internally reflective material redirects light which might exit through the second major edge portion 47 back into the second substrate material 39. In other embodiments, the second major edge portion 47 may not be coated and may permit light to escape and thus illuminate the second outer edge 41.

The first substrate material 24 includes a plurality of first light extracting disruptions 70 which form the first grouping 15 of spaced foreground visual elements 16. The term “disruption” means a deviation in the internal or surface geometry of the substrate material which causes a portion of internal transmitted light encountering the deviation to be deflected by the deviation and indirectly emitted out of the substrate material through either of the generally planar major surfaces of the panel, or which causes a portion of transmitted light to be absorbed by the deviation and directly emitted out of the substrate material through the deviation. The specific paths followed by such “emitted light” can vary. Such emitted light will cause the disruption to fluoresce or glow when viewed in relation to other portions of the substrate material. In the illustrated embodiment, a substantial portion of emitted light eventually passes out of the first substrate material 24 through the first major forward surface 26. The first light extracting disruptions 70 are observed to fluoresce or glow in relation to other portions of the first substrate material 24.

In the illustrated embodiment (see FIG. 3), the first light extracting disruptions 70 are first intrusions 72 formed into the first substrate material 24. Each first intrusion 72 is formed by an incision into the first substrate material 24 at the first major rear surface 34 to define therein a first minor intrusion surface 74. The first minor intrusion surface 74 extends from the first major rear surface 34 generally in the forward direction toward the first major forward surface 26. The first minor intrusion surface 74 terminates at a first minor terminal end 75. The first minor terminal end 75 is spaced from the first major forward surface 26. The intersection of each first minor intrusion surface 74 with the first major rear surface 34 defines a first mouth 76. The first minor intrusion surface 74 cooperates with the first minor terminal end 75 and the first mouth 76 to define a first minor void space 78. In the specific embodiment illustrated, a portion of transmitted light in the first substrate material 24 encounters the first minor intrusion surface 74 and is emitted from the first substrate material 24. The first intrusions 72 thus are observed to fluoresce in relation to other portions of the first substrate material 24.

The incisions may be formed by any suitable method. In the illustrated embodiment, the incisions are formed by machining the substrate material with a machine tool bit. In one embodiment, the machine tool bit is a half-round cutting tool. In one embodiment, the machine tool bit is a ball end mill. Different tools can be used with suitable results. In other specific embodiments (not shown), for example, incisions can be created by chemical etching, laser cutting or sandblasting the substrate material.

The second substrate material 39 includes a plurality of second light extracting disruptions 80 which form the second grouping 17 of spaced background visual elements 18. In the illustrated embodiment, a portion of emitted light eventually passes out of the second substrate material 39 through the second major forward surface 38. The emitted light then passes through the first panel 22 and out through the first major forward surface 26. The second light extracting disruptions 80 are observed to fluoresce or glow in relation to other portions of the second substrate material 39 and portions of the first substrate material 24.

In the illustrated embodiment, the second light extracting disruptions 80 are second intrusions 82 formed into the second substrate material 39. Each second intrusion 82 is formed by an incision into the second substrate material 39 at the second major rear surface 46 to define therein a second minor intrusion surface 84. The second minor intrusion surface 84 extends from the second major rear surface 84 generally in the forward direction toward the second major forward surface 38. The second minor intrusion surface 84 terminates at a second minor terminal end 85. The second minor terminal end 85 is spaced from the second major forward surface 38. The intersection of each second minor intrusion surface 84 with the second major rear surface 46 defines a second mouth 86. The second minor intrusion surface 84 cooperates with the second minor terminal end 85 and the second mouth 86 to define a second minor void space 87. In the specific embodiment illustrated, a portion of transmitted light in the second substrate material 39 encounters the second minor intrusion surface 84 and is emitted from the second substrate material 39. The second intrusions 82 thus are observed to fluoresce in relation to other portions of the second substrate material 39 and portions of the first substrate material 24.

The display apparatus 10 also includes a light source 80 for illuminating the first and second illuminated panels 22 and 23. In the illustrated embodiment, the light source 80 includes spaced first and second light sources 84 and 88. The first light source 84 illuminates the first illuminated panel 22. The first light source 84 produces light which illuminates the first edge light entrance area 33 and is directed into and passes through the first edge light entrance area 33 into the first substrate material 24. Although any suitable light source may be utilized, in one embodiment, the first light source 84 comprises an illuminable first light emitting diode (LED) 90. The first LED 90 is operably connected to a suitable power supply circuit (not shown), as is known in the art. In the specific embodiment illustrated, the power supply circuit is formed on a printed circuit board assembly 98. Although the first LED 90 can be otherwise supported, in the illustrated embodiment, the first LED 90 is mounted on and supported by the printed circuit board assembly 98. The first LED 90 is supported adjacent the first outer edge 29 in close proximity to the first edge light entrance area 33. When operated, the first LED 90 produces light which illuminates the first edge light entrance area 33 and is transmitted through the first edge light entrance area 33 into the first substrate material 24. The light passing into the first substrate material 24 is identified as “transmitted light”.

In the specific embodiment illustrated in FIGS. 1 through 3, the first light source 84 comprises a first series 100 of multiple, spaced first LED's 90. The first edge light entrance area 33 is elongated and comprises substantially the entire length of the bottom edge portion 29B of the first panel 22. The first series 100 of first LED's 90 is spaced along and supported adjacent the elongated bottom edge portion 29B of the first panel 22. Each first LED 90 is thus supported in close proximity to and in luminal communication with the elongated first edge light entrance area 33. When operated, the first series 100 of first LED's 90 produce light which illuminates substantially the entire length of the first edge light entrance area 33 and passes through the first edge light entrance area 33 into the first substrate material 24. The light entering the first substrate material 24 in this manner is “transmitted light” which travels in the first substrate material 24 in the direction parallel to the first major forward surface 26 and the first major rear surface 34.

The light source 80 also includes the second light source 88 which illuminates the second illuminated panel 23. The second light source 88 produces light which illuminates the second edge light entrance area 45 and is directed into and passes through the second edge light entrance area 45 into the second substrate material 39. Although any suitable light source may be utilized, in one embodiment, the second light source 88 comprises an illuminable second light emitting diode (LED) 110. The second LED 110 is operably connected to a suitable power supply circuit. In the specific embodiment illustrated, the power supply circuit is formed by the printed circuit board assembly 98. Although the second LED 110 can be otherwise supported, in the illustrated embodiment, the second LED 110 is mounted on and supported by the printed circuit board assembly 98. The second LED 110 is supported adjacent the second outer edge 41 in close proximity to the second edge light entrance area 45. When operated, the second LED 110 produces light which illuminates the second edge light entrance area 45 and is transmitted through the second edge light entrance area 45 into the second substrate material 39.

In the specific embodiment illustrated in FIGS. 1 through 3, the second light source 88 comprises a second series 120 of multiple, spaced second LED's 110. The second edge light entrance area 45 is elongated and comprises substantially the entire length of the bottom edge portion 41B of the second panel 23. The second series 120 of second LED's 110 is spaced a long and supported adjacent the elongated bottom edge portion 41B of the second panel 23. Each second LED 110 is thus supported in close proximity to the elongated second edge light entrance area 45. When operated, the second series 120 of second LED's 110 produce light which illuminates substantially the entire length of the second edge light entrance area 45 and is transmitted through the second edge light entrance area 45 into the second substrate material 39.

The display apparatus 10 includes a base 130 which supports the first and second panels 22 and 23. In the illustrated embodiment, the base 130 is disposed upon an environmental surface, such as the top of a table, and supports the first and second panels 22 and 23 above the surface in an orientation convenient for viewing by a viewer. In the illustrated embodiment, the base 130 receives the respective bottom edge portions 29B and 41B of the first and second panels 22 and 23. The base 130 includes conventional mounting means (not shown) which engage and fixedly support the first and second panels 22 and 23. Although any conventional mounting means can be utilized, in the illustrated embodiment, the mounting means comprises a set of adjustable set screws (not shown) which frictionally engage opposing surfaces of the first and second panels 22 and 23. The mounting means thus engages and fixedly supports the first and second panels 22 and 23 in a fixed position.

Inside the base 130, the bottom edge portion 29B of the first panel 22 is supported adjacent the first series 100 of spaced first LED's 90. The first LED's 90 also are supported inside the base 130 by the printed circuit board assembly 98. The first LED's 90 thus are positioned such that light produced by operation of the first LED's 90 illuminates the first edge light entrance area 33 and is transmitted through the first edge light entrance area 33 into the first substrate material 24. The bottom edge portion 41B of the second panel 23 is similarly supported adjacent the second series 120 of spaced second LED's 110. The second LED's 110 also are supported inside the base 130 by the printed circuit board assembly 98. The second LED's 110 are positioned such that light produced by operation of the second LED's 110 illuminates the second edge light entrance area 45 and is transmitted through the second edge light entrance area 45 into the second substrate material 39.

The first substrate material 24 is a substantially transparent light emitting material of any suitable type. Transparent acrylic or polycarbonate material is suitable. In one embodiment, transparent acrylic material is favored because of the relative ease of machining incisions to create the light extracting intrusions. In one embodiment, the first substrate material 24 is colorless. In an alternative embodiment, the first substrate material 24 is of any desired color. In embodiments where the first substrate material 24 is colored, the degree of pigmentation or opaqueness is sufficiently low that illuminated elements in the second panel 23 are also viewable by the viewer through the first substrate material 24.

The second substrate material 39 is a substantially transparent light emitting material of any suitable type. Transparent acrylic or polycarbonate material is suitable. In one embodiment, transparent acrylic material is favored for ease of machining. The second substrate material 39 may be of any desired color. In one embodiment, where the first substrate material 24 is colorless, the second substrate material may also be colorless. In embodiments where the second substrate material 39 is colored, the degree of opaqueness of the second substrate material 39 is sufficiently low that illuminated elements in the second panel or subsequent panels are viewable by the viewer through the first substrate material 24 and the second substrate material 39.

In one embodiment, the first panel 22 is formed of substantially transparent colorless first substrate material 24, and the second panel 23 is formed of substantially transparent second substrate material 39 of a color C2. In one embodiment, the first panel 22 is formed of substantially transparent first substrate material 24 of a first color C1, and the second panel 23 is formed of substantially transparent second substrate material 39 of a second color C2. In one embodiment, both the first and second panels 22 and 23 are substantially colorless (or the same color) and the first series 100 of first LED's 90 produces colored light of a first color C1, and the second series 120 of second LED's 110 produces colored light of a second color C2.

Operation of the visual display apparatus 10 is as follows. Operation of the power circuit causes the first LED's 90 to emit light which illuminates the first edge light entrance area 33 and is transmitted through the first edge light entrance area 33 into the first substrate material 24. Portions of transmitted light in the first substrate material 24 encounter the first minor intrusion surfaces 74 of the plurality of first intrusions 72 and are emitted from the first substrate material 24. The first intrusions 72 thus are observed to fluoresce in relation to other portions of the first substrate material 24. Since the second panel 23 is viewed through the first substrate material 24, the first intrusions 72 are also observed to fluoresce in the foreground in relation to the second substrate material 39 and the second intrusions 82. Operation of the power circuit also causes the second LED's 110 to emit light which illuminates the second edge light entrance area 45 and is transmitted through the second edge light entrance area 45 into the second substrate material 39. Portions of transmitted light in the second substrate material 39 encounter the second minor intrusion surfaces 84 of the plurality of second intrusions 82 and are emitted from the second substrate material 39. The second intrusions 82 thus are observed to fluoresce in relation to other portions of the second substrate material 39 and the first substrate material 24. Since the second panel 23 is viewed through the first substrate material 24, the second intrusions 82 are also observed to fluoresce in the background in relation to the first substrate material 24 and the first intrusions 72.

In one alternative embodiment (not shown), one or more of the stacked panels may not be individually illuminated by edge lighting and instead may be illuminated by light transmitted from other illuminated panels.

An embodiment of the invention is illustrated in FIG. 5 wherein the light source 80 comprises a single series 130 of LED's 134 which illuminate both adjacent first and second panels 136 and 138. In one specific embodiment according to the construction shown in FIG. 5, the first panel 136 is colorless and the second panel 138 is of a color C2. Operation of the LED's 134 produces light of a third color C3 and illuminates both the first and second edge light entrance areas 142 and 144 of the respective first and second panels 136 and 138. Portions of the transmitted light are emitted upon encountering the respective first and second intrusions 146 and 148. The first intrusions 146 are observed to fluoresce in the third color C3 and the second intrusions 148 fluoresce in a composite blend of colors C2 and C3. In the condition where the LED produces white light, the first intrusions 146 fluoresce in white and the second intrusions fluoresce in color C2.

Although embodiments of the invention have been described in detail for purposes of illustration, various modifications may be made without departing from the spirit and scope of the invention. Accordingly, the invention is not to be limited, except according to the following claims.

We claim:

1. A visual display apparatus, comprising:
a first panel, said first panel comprising a substantially transparent first substrate material, said first substrate material being substantially colorless, said first substrate material defining a first major forward surface and an opposed first major rear surface spaced in a rearward direction from said first major forward surface, said first substrate material defining a continuous first outer edge connecting said first major forward surface and said first major rear surface, said first outer edge comprising a first edge light entrance area;
a second panel disposed in parallel relation to said first panel, said second panel comprising a substantially transparent second substrate material, said second substrate material having a color, said second substrate material defining a second major forward surface and an opposed second major rear surface spaced in a rearward direction from said second major forward surface, said second substrate material defining a continuous second outer edge connecting said second major forward surface and said second major rear surface, said second outer edge comprising a second edge light entrance area;
a light source, said light source being operable to produce light for illuminating said first edge light entrance area and said second edge light entrance area;
said first edge light entrance area being adapted to transmit the illuminating light into said first substrate material to illuminate said first panel;
said second edge light entrance area being adapted to transmit the illuminating light into said second substrate material to illuminate said second panel;
said first substrate material having defined therein a plurality of spaced light extracting first deformations disposed to cause emission of a portion of said illuminating light in said first panel; and
said second substrate material having defined therein a plurality of spaced light extracting second deformations disposed to cause emission of a portion of said illuminating light in said second panel.

2. A visual display apparatus according to claim 1, wherein:
each of said first deformations has a first minor surface intersecting said first major rear surface, and said first minor surface being disposed to cause emission of light in said first panel; and
each of said second deformations having a second minor surface intersecting said second major rear surface, and said second minor surface being disposed to cause emission of light in said second panel.

3. A visual display apparatus according to claim 1, wherein said light source comprises an LED which is operable to illuminate said first edge light entrance area and said second edge light entrance area.

4. A visual display apparatus according to claim 1, wherein said first substrate material is substantially colorless and said second substrate material is colored.

5. A visual display apparatus, comprising:
a first panel, said first panel comprising a substantially transparent first substrate material of a first color, said first substrate material defining a first major forward surface and an opposed first major rear surface spaced in a rearward direction from said first major forward surface, said first substrate material defining a continuous first outer edge connecting said first major forward surface and said first major rear surface, and said first outer edge comprising a first edge light entrance area;
a second panel disposed in parallel relation to said first panel, said second panel comprising a substantially transparent second substrate material, said second substrate material defining a second major forward surface and an opposed second major rear surface spaced in a rearward direction from said second major forward surface, said second substrate material defining a continuous second outer edge connecting said second major forward surface and said second major rear surface, said second outer edge comprising a second edge light entrance area;
a light source, said light source being operable to produce light for illuminating said first edge light entrance area and said second edge light entrance area;
said first edge light entrance area being adapted to transmit the illuminating light into said first substrate material to illuminate said first panel;
said second edge light entrance area being adapted to transmit the illuminating light into said second substrate material to illuminate said second panel;
said first substrate material having defined therein a plurality of spaced light extracting first deformations, each of said first deformations having a first minor surface intersecting said first major rear surface, and said first minor surface being disposed to cause emission of a portion of said illuminating light in said first panel; and
said second substrate material having defined therein a plurality of spaced light extracting second deformations, each of said second deformations having a second minor surface intersecting said second major rear surface and said second minor surface being disposed to cause emission of a portion of said illuminating light in said second panel.

6. A visual display apparatus according to claim 5, wherein said light source comprises an LED which is operable to illuminate said first edge light entrance area and said second edge light entrance area.

7. A visual display apparatus according to claim 5, wherein said first substrate material is substantially colorless and said second substrate material is colored.

8. A visual display apparatus, comprising:
a first panel, said first panel comprising a substantially transparent first substrate material of a first color, said first substrate material defining a first major forward surface and an opposed first major rear surface spaced in a rearward direction from said first major forward surface, said first substrate material defining a continuous first outer edge connecting said first major forward surface and said first major rear surface, and said first outer edge comprising a first edge light entrance area;
a second panel disposed in parallel relation to said first panel, said second panel comprising a substantially transparent second substrate material of a second color, said second color being different from said first color, said second substrate material defining a second major forward surface and an opposed second major rear surface spaced in a rearward direction from said second major forward surface, said second substrate material defining a continuous second outer edge connecting said second major forward surface and said second major rear surface, and said second outer edge comprising a second edge light entrance area;
a light source, said light source being operable to produce light of a third color, said light illuminating said first edge light entrance area and said second edge light entrance area;
said first edge light entrance area being adapted to transmit said light into said first substrate material;
said second edge light entrance area being adapted to transmit said light into said second substrate material;
said first substrate material having defined therein a plurality of spaced light extracting first deformations, each of said first deformations being disposed to cause emission of light in said first panel in a first composite color, the first composite color being a ratio of the first color and the second color; and
said second substrate material having defined therein a plurality of spaced light extracting second deformations, each of said second being disposed to cause emission of light in said second panel in a second composite color, the second composite color being a ratio of the first color and the second color.

9. A visual display apparatus according to claim 8, wherein:
each of said first deformations has a first minor surface intersecting said first major rear surface, and said first minor surface being disposed to cause emission of light in said first panel; and
each of said second deformations having a second minor surface intersecting said second major rear surface, and said second minor surface being disposed to cause emission of light in said second panel.

10. A visual display apparatus according to claim 8, wherein said light source comprises an LED which is operable to illuminate said first edge light entrance area and said second edge light entrance area.
